(19) United States
(12) Patent Application Publication
(10) Pub. No.: US 2025/0360754 A1
(43) Pub. Date: Nov. 27, 2025

(54) COUPLER RING FOR VEHICULAR WHEEL BEARING, VEHICULAR WHEEL BEARING INCLUDING SAME, AND MANUFACTURING METHOD THEREOF

(71) Applicant: ILJIN GLOBAL CO., LTD., Seoul (KR)

(72) Inventors: Dongho GEUM, Seoul (KR); Junho LEE, Seoul (KR)

(73) Assignee: ILJIN GLOBAL CO., LTD., Seoul (KR)

(21) Appl. No.: 19/218,961

(22) Filed: May 27, 2025

(30) Foreign Application Priority Data
May 27, 2024 (KR) 10-2024-0068348

(51) Int. Cl. B60B 27/00; B60B 27/02; F16C 43/04; F16D 1/10

(52) U.S. Cl. CPC B60B 27/0078; F16C 43/04; F16D 1/10; B60B 27/02; F16C 2326/02

(57) ABSTRACT

A coupler ring applied to a vehicular wheel bearing according to an example embodiment of the present disclosure includes: a wheel-side side surface, a vehicle-body-side side surface, an inner peripheral surface connecting the wheel-side side surface and the vehicle-body-side side surface, and an outer peripheral surface connecting the wheel-side side surface and the vehicle-body-side side. An inner coupler-ring spline portion is formed on the inner peripheral surface, an outer coupler-ring spline portion, which is engaged with a ring gear, is formed on the outer peripheral surface, and a height of the outer coupler-ring spline portion on a vehicle-body side is formed to be greater than that on a wheel side.

### CROSS-REFERENCE TO RELATED APPLICATIONS

This application claims priority to Korean Patent Application No. 10-2024-0068348 filed on May 27, 2024, the entire contents of which are herein incorporated by reference.

### TECHNICAL FIELD

The present disclosure relates to a coupler ring for a vehicular wheel bearing, the vehicular wheel bearing including the same, and a manufacturing method thereof, and more particularly to a coupler ring for a vehicular wheel bearing, which is applied to a part-time-type four-wheel-drive vehicle and minimizes the negative effects such as deformation of the coupler ring that inevitably occurs due to an axial force caused by orbital forming, thereby enabling stable power transmission, the vehicular wheel bearing including the same, and a manufacturing method thereof.

### BACKGROUND

As a four-wheel-drive vehicle, a full-time-type four-wheel-drive vehicle and a part-time-type four-wheel-drive vehicle have been known. Among these, the part-time-type four-wheel-drive vehicle is a vehicle which is capable of being changed between a two-wheel-drive state and a four-wheel-drive state. For example, a driven wheel may be separated from a vehicle shaft of a driving system such that the driven wheel is in a free state and does not rotate relative to a vehicle body. Further, the driven wheel may be connected to the vehicle shaft of the driving system such that the driven wheel is in a lock state and receives a driving power from an engine. The separation and connection of the driven wheel from and to the vehicle body may be implemented by a coupler ring and a gear ring.

FIG. 1 is a diagram illustrating an orbital forming process performed on a wheel bearing in the related art. A coupler ring 1 has a spline portion formed on each of an inner peripheral surface and an outer peripheral surface. The spline portion formed on the inner peripheral surface of the coupler ring 1 is fitted into a spline portion formed on an outer peripheral surface of a wheel hub. A vehicle-body-side end portion is bent (for example, orbital-formed) to finally fix an inner ring 2 and the coupler ring 1 to each other. A gear ring (not illustrated) of a clutch is slidable in an axial direction on an outer peripheral surface of the coupler ring 1 thus finally fixed. As the gear ring slides toward the wheel, a spline portion formed on an outer peripheral surface of the gear ring is fitted into the spline portion formed on the outer peripheral surface of the coupler ring 1 so that a rotational driving force from the clutch is transmitted to the wheel hub via the coupler ring 1. In contrast, when the gear ring slides toward the vehicle body, the gear ring and the coupler ring 1 are separated from each other so that the rotational drive force from the clutch is not transmitted to the coupler ring 1.

Meanwhile, in a structure of the wheel bearing in the related art, when a vehicle-body-side end portion of the wheel hub is bent to form a bent portion 3 (as illustrated in FIG. 1), a remarkable amount of load may be applied to the coupler ring 1, which causes deformation of the coupler ring 1.

Since the coupler ring 1 has the spline portion formed on the outer peripheral surface thereof to be coupled to the spline portion of the gear ring, it requires a certain level or more of accuracy. Thus, due to the deformation of the coupler ring 1, defects may occur in the coupling between the spline portions. This is not desirable for power transmission.

As illustrated in FIG. 1, in order to solve matters such as the deformation of the coupler ring in the related art, a technique for fixing the outer peripheral surface of the coupler ring 1 with a separate equipment (for example, a fixing jig 4) during the orbital forming process has been proposed. However, the separate equipment needs to be provided and the orbital forming process becomes complicated. In addition, the fixing jig 4 needs to have a spline formed to be engaged with the outer peripheral surface of the coupler ring. This makes a manufacturing process difficult. Further, it is unclear whether the fixing jig 4 prevents a minute deformation of several microns from being generated at the outer peripheral surface of the coupler ring.

### PRIOR ART DOCUMENT

### Patent Document

Patent Document 1: Japanese Laid-Open Patent Publication No. 2013-024393 (published on Feb. 4, 2013)

### SUMMARY

The present disclosure was made to solve the above-mentioned matters, and the present disclosure is for the purpose of providing a coupler ring for a vehicular wheel bearing, which minimizes the negative effects such as deformation of the coupler ring that inevitably occurs due to an axial force caused by orbital forming, thereby enabling stable power transmission, the vehicular wheel bearing including the same, and a method manufacturing thereof.

According to an example embodiment of the present disclosure, a coupler ring 400 applied to a vehicular wheel bearing 10 may include a wheel-side side surface 482, a vehicle-body-side side surface 484, an inner peripheral surface 486 connecting the wheel-side side surface 482 and the vehicle-body-side side surface 484, and an outer peripheral surface 488 connecting the wheel-side side surface 482 and the vehicle-body-side side 484. An inner coupler-ring spline portion 420 may be formed on the inner peripheral surface 486, n outer coupler-ring spline portion 460, which is engaged with a ring gear, may be on the outer peripheral surface 488, and a height of the outer coupler-ring spline portion 460 on a vehicle-body side may be formed to be greater than on a wheel side.

In an aspect, the height of the outer coupler-ring spline portion 460 may be set to increase toward a vehicle-body-side end F.

In an aspect, the height of the outer coupler-ring spline portion 460 may be set to decrease gradually from a vehicle-body-side end F toward the wheel side.

In an aspect, a difference Δh between a height h5 of the outer coupler-ring spline portion 460 at the vehicle-body-side end F and a height h6 of the outer coupler-ring spline portion 460 at a wheel-side end E may fall within a range of 10 to 50 μm.

In an aspect, a bumper may be installed on the outer coupler ring spline portion 460, and the wheel-side end E of the outer coupler-ring spline portion 460 may be brought into contact with a vehicle-body-side side surface of the bumper.

In an aspect, the outer coupler-ring spline portion 460 may be formed such that tooth mountains and tooth valleys are arranged in an alternate manner, and an outer peripheral surface of the outer coupler-ring spline portion 460, which forms the tooth mountains, may be formed as an inclined surface at a predetermined inclination angle. The predetermined inclination angle of the outer peripheral surface may be defined by precision processing of the tooth mountains.

In an aspect, a width W of each of tooth mountains 462 of the outer coupler-ring spline portion 460 on the vehicle-body side may be formed to be greater than on the wheel side.

In an aspect, a height of a tooth valley 466 of the outer coupler-ring spline portion 460 on the vehicle-body side may be formed to be greater than on the wheel side.

According to another example embodiment of the present disclosure, a method of manufacturing a vehicular wheel bearing to which the coupler ring of any one of the aforementioned configurations is applied, may include: mounting an inner ring 300 on an outer peripheral surface of a wheel hub 100; mounting a coupler ring 400 on the outer peripheral surface of the wheel hub 100 to be brought into contact with the inner ring 300; and bending a vehicle-body-side end portion of the wheel hub 100 to form a bent portion 130 and applying a preload to the coupler ring 400. In the applying the preload, an outer coupler-ring spline portion 460 may be raised and deformed such that a difference Δh between a height h5 of the outer coupler-ring spline portion 460 at a vehicle-body-side end F and a height h6 of the outer coupler-ring spline portion 460 at a wheel-side end E is decreased.

In an aspect, in the applying the preload, the outer coupler ring spline portion 460 may be raised by 20 μm or more at the wheel-side end E.

In an aspect, in the applying the preload, a load in a range of 6 to 9 tons may be applied to the vehicle-body-side side surface 484.

In an aspect, the load applied to the vehicle-body-side side surface 484 in the applying the preload may be set such that a raise deformation magnitude ΔS of the outer coupler-ring spline portion 460 at the wheel-side end E does not exceed a difference Δh between the height h5 of the outer coupler-ring spline portion 460 at the vehicle-body-side end F and the height h6 of the outer coupler-ring spline portion 460 at the wheel-side end E.

According to another example embodiment of the present disclosure, a vehicular wheel bearing to which the coupler ring of any one of the aforementioned configurations is finally mounted by an orbital forming process is provided. In the coupler ring finally mounted on vehicular wheel bearing, a difference Δh between a height h5 of an outer coupler-ring spline portion 460 at a vehicle-body-side end F and a height h6 of the outer coupler-ring spline portion 460 at a wheel-side end E may be decreased.

According to a coupler ring applied to a vehicular wheel bearing of the present disclosure, by inclining an outer peripheral surface of an outer coupler-ring spline portion of the coupler ring, it is possible to suppress the outer peripheral surface of the coupler ring from being raised unevenly and deformed by an axial force during an orbital forming, and improve parallelism of the outer coupler-ring spline portion compared to the related art.

Accordingly, it is possible to minimize undesirable effects such as deformation of the coupler ring that is inevitably caused by the axial force during the orbital forming and implement a stable power transmission.

### BRIEF DESCRIPTION OF THE DRAWINGS

FIG. 1 is a diagram for explaining an orbital forming process performed on a wheel bearing in the related art.

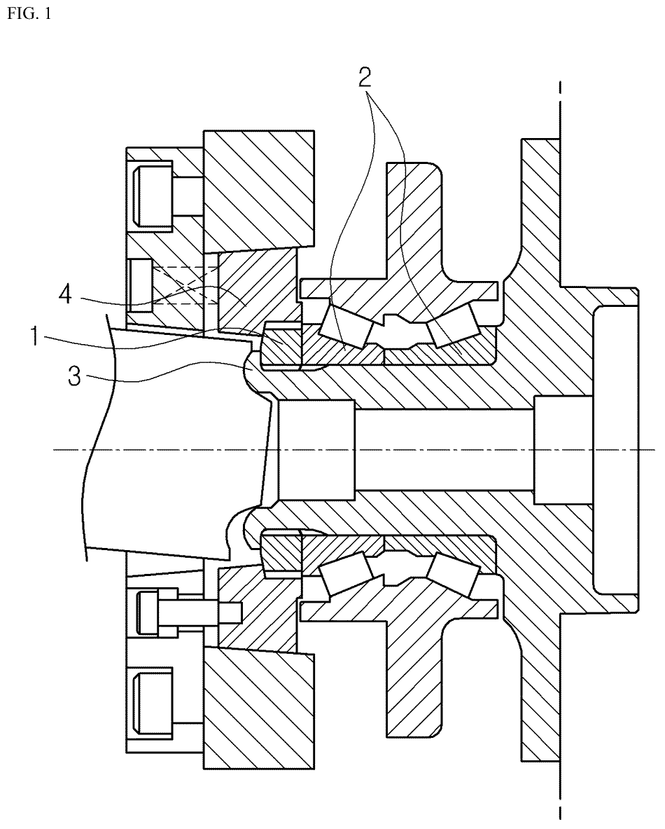

FIG. 2 is a cross-sectional view of a vehicular wheel bearing according to an example embodiment of the present disclosure.

FIG. 3 is an enlarged cross-sectional view of the wheel bearing according to an example embodiment of the present disclosure.

FIG. 4 is a diagram for explaining a phenomenon in which a coupler ring is deformed during an orbital forming process.

FIG. 5 is a cross-sectional view of the coupler ring before the orbital forming process according to an example embodiment of the present disclosure.

FIG. 6 is a cross-sectional view of the coupler ring deformed during the orbital forming process according to an example embodiment of the present disclosure.

FIG. 7 illustrates a cross-section of an outer coupler-ring spline portion according to an example embodiment of the present disclosure.

### DETAILED DESCRIPTION

Hereinafter, preferred example embodiments of the present disclosure will be described in detail with reference to the accompanying drawings.

In order to clearly describe the present disclosure, detailed descriptions of parts irrelevant to the present disclosure will be omitted, and the same reference numerals will be given to the same constituent elements throughout the specification. Further, a shape and size of each constituent element illustrated in the drawings are arbitrarily illustrated for the sake of convenience in description, and hence the present disclosure is not necessarily limited to the shape and size illustrated. That is, it is to be understood that specific shapes, structures, and characteristics described herein may be modified from an example embodiment to another embodiment without departing from the spirit and scope of the present disclosure. Positions or arrangements of individual constituent elements may also be modified without departing from the spirit and scope of the present disclosure.

Therefore, the detailed description described below is not to be taken in a limiting sense, and the scope of the present disclosure is to be taken as covering the scope claimed by the appended claims and their equivalents.

When a part “comprises or includes” a constituent element through the specification, this means that the part may further include other constituent elements, rather than excluding other constituent elements, unless other stated.

Throughout the specification, in all constituent elements constituting a wheel bearing, a direction toward a wheel with reference to an extension direction of a rotational axis of a wheel hub is referred to as a “wheel side,” and a direction opposite the direction toward the wheel is referred to as a “vehicle-body side.”

Further, in all the constituent elements constituting the wheel bearing, a direction toward the rotational axis with reference to a direction perpendicular to the rotational axis of the wheel hub is referred to as a “radially inward direction”, and a direction opposite the direction toward the rotational axis is referred to as a “radially outward direction”.

Parts denoted by the same reference numerals throughout the specification refer to the same or similar constituent elements.

Hereinafter, an overall structure of a vehicular wheel bearing will be first described, and a structure of a coupler ring and a structure of an outer peripheral surface of the coupler ring will be sequentially described in more detail.

### 1. Overall Structure of Vehicular Wheel Bearing

Hereinafter, preferred example embodiments of the present disclosure will be described in more detail with reference to the accompanying drawings.

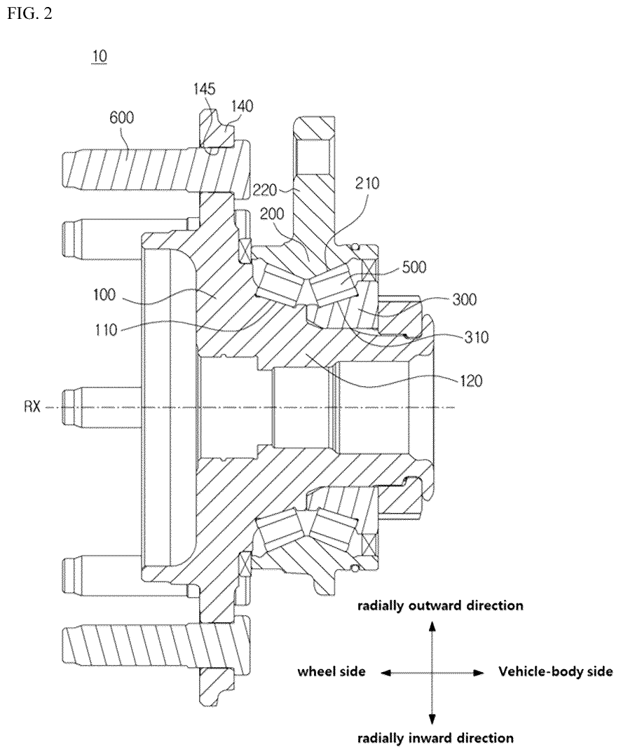

FIG. 2 is a cross-sectional view of a vehicular wheel bearing according to an example embodiment of the present disclosure. For the sake of convenience in description, the wheel bearing illustrated in FIG. 2 is merely one of various kinds of wheel bearings, and the technical ideas of the present disclosure may be applied to various kinds of wheel bearings without being limited to the wheel bearings illustrated herein.

Referring to FIG. 2, a vehicular wheel bearing 10 according to an example embodiment of the present disclosure may be used for a wheel bearing of a part-time-type four-wheel-drive vehicle.

The vehicular wheel bearing 10 may include a wheel hub 100, at least one inner ring 300 coupled to an outer peripheral surface of the wheel hub 100, an outer ring 200 provided to be spaced apart by a certain distance from the wheel hub 100 and the at least one inner ring 300 in the radially outward direction, and rolling bodies 500 provided between the wheel hub 100 to which the at least one inner ring 300 is coupled and the outer ring 200.

While one inner ring 300 has been illustrated to be mounted on the wheel hub 100 in FIG. 2, the wheel bearing of the present disclosure is not limited to such a structure. It should be understood that two or more (for example, a pair of) inner rings may be mounted on the wheel hub 100. In addition, in this specification, the expression “the rolling bodies are provided between the wheel hub 100 to which at least one inner ring 300 is coupled and the outer ring 200” should be understood as encompassing not only a configuration in which one inner ring is applied to the wheel hub, but also a configuration in which multiple inner rings are applied to the wheel hub, as illustrated in FIG. 2. That is, in FIG. 2, wheel-side rolling bodies (in other words, rolling bodies at an outboard side) are illustrated to be mounted between the wheel hub and the outer ring, and vehicle-body-side rolling bodies (in other words, rolling bodies at an inboard side) are illustrated to be mounted between the inner ring and the outer ring. However, in a case in which a pair of inner rings is applied, the wheel-side rolling bodies and the vehicle-body-side rolling bodies may be provided between the pair of inner rings and the outer ring. In this specification, the expression “the rolling bodies are provided between the wheel hub to which at least one inner ring is coupled and the outer ring” should be understood as encompassing such an example. Hereinafter, an example in which one inner ring is applied will be described in detail with reference to FIG. 2.

The outer ring 200 is coupled to a vehicle body (for example, a knuckle (not illustrated)). The outer ring 200 includes a vehicle-body installation flange portion 220 protruding in the radially outward direction. The vehicle-body installation flange portion 220 of the outer ring 200 may be coupled to the knuckle via a knuckle bolt which penetrates in an axial direction.

According to an example embodiment of the present disclosure, the wheel hub 100 may have a cylindrical shape extending in the axial direction. At least one inner ring 300 is coupled to the outer peripheral surface of the wheel hub 100 in a press-fitting manner.

The wheel hub 100 may be connected to the wheel and is rotatable about an imaginary rotational axis RX parallel to the axial direction. The inner ring 300 may be formed in a ring shape and may be configured to surround at least a part of an outer peripheral surface of the wheel hub 100. The inner ring 300 is configured to rotate together with the wheel hub 100. The wheel hub 100 is coupled to the wheel. Thus, when the wheel hub 100 rotates about the imaginary rotational axis RX parallel to the axial direction with the rotation of the wheel, the inner ring 300 may also rotate together with the wheel hub 100 about the imaginary rotational axis RX.

For example, the wheel hub 100 may include a wheel installation flange 140 integrally formed to install the wheel (not illustrated) thereon at a wheel-side end portion. As illustrated in FIG. 2, wheel mounting bolts 600 may be inserted into wheel mounting openings 145 formed to extend in the axial direction and penetrate through the wheel installation flange 140 of the wheel hub 100, respectively. The wheel mounting bolts 600 may be arranged to be spaced apart from each other in a circumferential direction in a concentric relationship with the imaginary rotational axis RX. Thus, the wheel hub 100 may be coupled to the wheel with the wheel mounting bolts 600.

The wheel hub 100 and the inner ring 300 have inner raceway surface 110 and 310 tapered on outer peripheries thereof, respectively, and are press-fitted into each other at a certain interference magnitude by a small-diameter portion 120 of the wheel hub 100.

The wheel bearing 10 may be configured to include a plurality of rolling bodies 500 provided in, for example, multiple rows. As an example, the rolling bodies 500 may be tapered rollers. The present disclosure is not limited thereto. The rolling bodies 500 may be balls, barrel rollers, or the like.

The outer ring 200 may be configured to include a vehicle-body installation flange portion 220 formed integrally to mount a knuckle (not illustrated) on an outer periphery thereof. The knuckle constitutes a suspension device. The outer ring 200 has multiple rows of outer raceway surfaces 210 formed in a tapered shape on an inner periphery thereof, which are exposed outward.

The plurality of rolling bodies 500 are accommodated to be rollable between the inner raceway surface 110 of the wheel hub 100, the inner raceway surface 310 of the inner ring 300 and the outer raceway surface 210 of the outer ring 200. By the rolling bodies 500, the inner ring 300 may rotate relative to the outer ring 200.

### 2. Structure of Coupler Ring

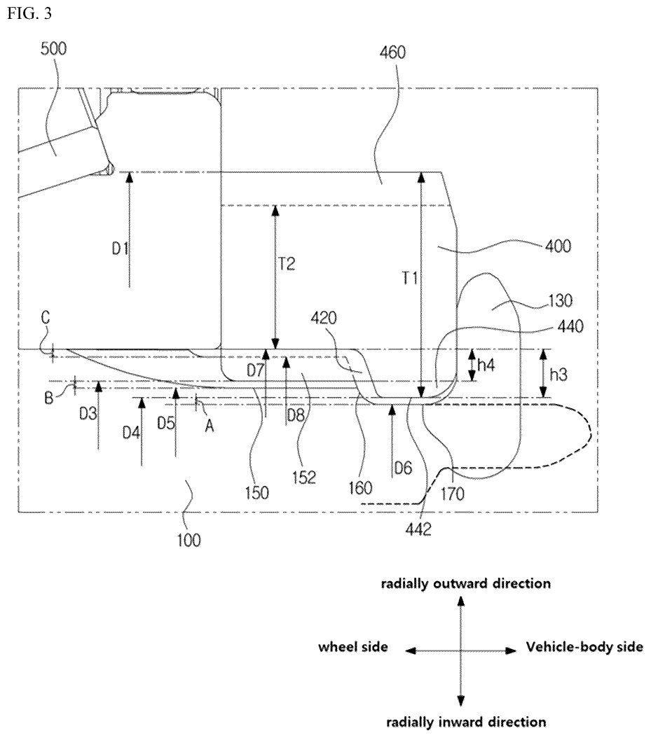

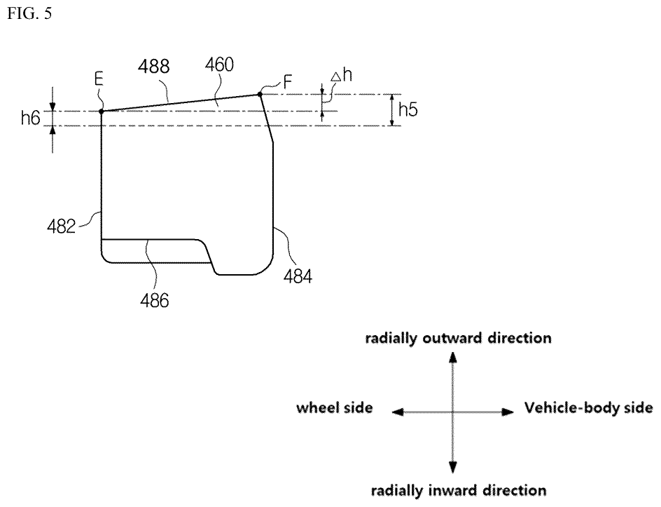

FIG. 3 is an enlarged cross-sectional view of a wheel bearing according to an example embodiment of the present disclosure. FIG. 5 is an enlarged cross-sectional view of the coupler ring before an orbital forming process according to an example embodiment of the present disclosure.

For the sake of easier understanding, the outer periphery of the wheel hub 100 coupled to the coupler ring 400 will be first described and subsequently, a structure of the coupler ring will be described.

When viewed from the wheel side, the outer periphery of the wheel hub 100 may have a first outer peripheral surface 150 on which an outer wheel-hub spline portion 152 is formed, a second outer peripheral surface 160 formed to extend obliquely in the radially inward direction from a vehicle-body-side end of the first outer peripheral surface 150 toward the wheel, and a third outer peripheral surface 170 formed to extend from the vehicle-body-side end of the second outer peripheral surface 160 toward the wheel. The outer wheel-hub spline portion 152 is formed in a spline structure in which tooth-shaped portions and tooth-shaped grooves are alternately arranged.

Further, as illustrated in FIG. 5, the coupler ring 400 according to an example embodiment of the present disclosure may be configured to have a wheel-side side surface 482, a vehicle-body-side side surface 484, an inner peripheral surface 486 connecting the wheel-side side surface 482 and the vehicle-body-side side surface 484, and an outer peripheral surface 488 connecting the wheel-side side surface 482 and the vehicle-body-side side surface 484.

An inner coupler-ring spline portion 420 is formed on the inner peripheral surface 486, and an outer coupler-ring spline portion 460 to be engaged with a gear is formed on the outer peripheral surface 488.

As illustrated in FIG. 3, in addition to the inner coupler-ring spline portion 420 as described above, the inner peripheral surface 486 of the coupler ring 400 may have a ring-shaped inner protrusion portion 440 protruded in the radially inward direction with not spline. The inner protrusion portion 440 has an inner peripheral surface 442 facing the third outer peripheral surface 170 of the wheel hub 100.

According to an example embodiment of the present disclosure, individual constituent elements of the coupler ring 400 may be provided in different coupling manners. That is, the inner coupler-ring spline portion 420 and the outer wheel-hub spline portion 152 may be coupled to each other in a forcibly fitting manner (that is, in a press-fitting manner), and the inner protrusion portion 440 (where no spline is formed) and the wheel hub 100 may be coupled to each other in a loosely fitting manner.

According to an example embodiment of the present disclosure, the coupling between the inner coupler-ring spline portion 420 and the outer wheel-hub spline portion 152 in the press-fitting manner may be implemented by press-fitting performed between a tooth side surface of the inner coupler-ring spline portion 420 and a tooth side surface of the outer wheel-hub spline portion 152.

According to an example embodiment of the present disclosure, a first interference magnitude A between the inner protrusion portion 440 of the coupler ring 400 and the wheel hub 100 (that is, (an inner diameter D4 of the inner protrusion portion of the coupler ring minus an outer diameter D6 of the third outer peripheral surface of the wheel hub)/2) may be set to be greater than zero. Further, according to an example embodiment of the present disclosure, the coupling between the inner coupler-ring spline portion 420 and the outer wheel-hub spline portion 152 in the press-fitting manner may be implemented between the tooth side surface of the inner coupler-ring spline portion 420 and the tooth side surface of the outer wheel-hub spline portion 152. In this case, both a second interference magnitude B between the inner coupler-ring spline portion 420 and the outer wheel-hub spline portion 152 (that is, (an inner diameter D3 of the tooth-shaped portion of the inner coupler-ring spline portion minus an outer diameter D5 of the tooth-shaped groove of the outer wheel-hub spline portion)/2) and a third interference magnitude C between the inner coupler-ring spline portion 420 and the outer wheel-hub spline portion 152 (that is, (an inner diameter D7 of the tooth-shaped groove of the inner coupler-ring spline portion minus an outer diameter D8 of the tooth-shaped portion of the outer wheel-hub spline portion)/2) may be set to be greater than zero.

Further, according to an example embodiment of the present disclosure, a height h3 of the inner protrusion portion 440 may be set to be greater than that of a tooth-shaped portion of the inner coupler-ring spline portion 420. More preferably, the inner peripheral surface 442 of the inner protrusion portion 440 may be disposed radially inward of the first outer peripheral surface 150 of the wheel hub 100. As an example, the inner peripheral surface 442 of the inner protrusion portion 440 may be disposed radially inward of the first outer peripheral surface 150 of the wheel hub 100 by a distance of 3 to 12 micrometer (μm) or more.

Further, according to an example embodiment of the present disclosure, a maximum thickness T1 of an area where the inner protrusion portion 440 of the coupler ring 400 is formed may be set in a range of 1.2 to 1.8 times a minimum thickness T2 of an area where the inner coupler-ring spline portion 420 of the coupler ring 400 is formed.

Further, according to an example embodiment of the present disclosure, the coupler ring 400 may be configured to further have the outer coupler-ring spline portion 460 formed to be engaged with a ring gear (not illustrated) on the outer peripheral surface thereof.

Although not illustrated in FIG. 3, a bumper may be installed on the outer coupler-ring spline portion 460. For example, the gear ring (not illustrated) may have an inner gear-ring spline portion on an inner peripheral surface thereof and may slide along the outer coupler-ring spline portion 460. During the sliding, the gear ring may hit the inner ring 300, thus causing an impact on the inner ring 300. In order to absorb such an impact, the bumper may be installed on at least a part of the outer coupler-ring spline portion 460.

One or more of the structures of the coupler ring described above (in particular, the structure of the inner peripheral surface) may serve to suppress the coupler ring from being deformed when a bent portion is brought into contact with the coupler ring in the radial direction during the orbital forming process.

### 3. Structure of Outer Peripheral Surface of Coupler Ring

As will be described later, during the orbital forming process, a bent portion 130 applies a load (axial force) to the vehicle-body-side side surface 484 of the coupler ring 400 in the axial direction. As a result, the wheel-side outer peripheral surface 488 of the coupler ring 400 may be raised during the orbital forming process. A phenomenon in which the wheel-side outer peripheral surface 488 of the coupler ring 400 is unevenly raised and deformed occurs due to the axial force. This phenomenon occurs regardless of whether or not the bent portion 130 is brought into close with the coupler ring 400 in the radial direction so that the coupler ring 400 is deformed.

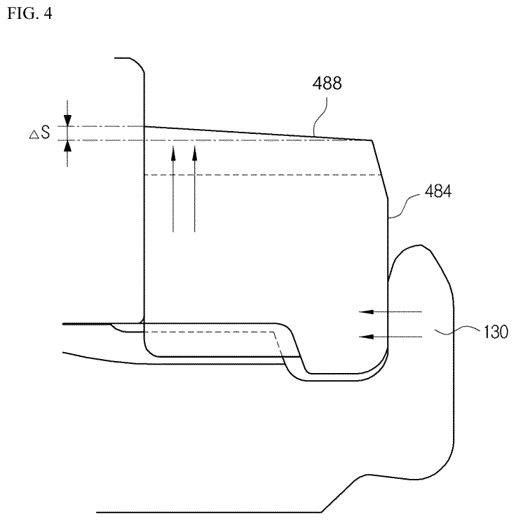

FIG. 4 is a diagram for explaining the phenomenon in which the coupler ring is deformed during the orbital forming process.

Before the orbital forming process, that is, before forming the bent portion 130, the outer ring 200, the inner ring 300, and the coupler ring 400 are sequentially coupled to the wheel hub 100 in a press-fitting manner from the wheel side. Thereafter, a vehicle-body-side end portion of the wheel hub 100 is bent (orbital-formed) in the radially outward direction to form the bent portion 130. As illustrated in FIG. 4, a pre-load needs to be applied to the vehicle-body-side side surface 484 of the coupler ring 400 during the orbital forming process (in consideration of a function of the orbital forming). As a result, a considerable amount of load may be applied as the axial force to the vehicle-body-side surface 484. The axial force may cause the outer peripheral surface of the outer coupler-ring spline portion to be finely raised unevenly and deformed along the axial direction.

In particular, the inventor(s) of the present disclosure found that such a fine raise deformation occurs on an opposite side of the vehicle-body side to which the load is applied, that is, on the wheel side. For example, when a load in a range of about 6 to 9 tons is applied, the wheel-side end of the outer coupler-ring spline portion may be raised by approximately 20 μm (in FIG. 4, a raise deformation amount of the wheel-side end is indicated by ΔS). FIG. 4 illustrates an example in which the bumper is not installed on the outer coupler-ring spline portion. However, even if the bumper is installed on the outer coupler-ring spline portion, the wheel-side end of the outer coupler-ring spline portion may be raised by approximately 20 μm. Here, the wheel-side end of the outer coupler-ring spline portion refers to an end which is brought into close with a vehicle-body-side side surface of the bumper.

As described above, due to the uneven raise deformation, the outer coupler-ring spline portion is less likely to be kept parallelism. This makes it difficult to couple the coupler ring with a clutch, thus making power transmission difficult.

In the present disclosure, (unlike the case in which the bent portion is brought into contact with the coupler ring in the radial direction so that the coupler ring is deformed) since the uneven raise deformation due to the axial force as described above inevitably occurs, (rather than suppressing the uneven raise deformation itself) an inclination is made for the outer peripheral surface of the outer coupler-ring spline portion by the axial force, which is expected when applying the preload during the orbital forming process, to solve the above-described matters.

FIG. 5 is a cross-sectional view of the coupler ring before the orbital forming process according to an example embodiment of the present disclosure. For the sake of easier understandings, the inclination of the outer peripheral surface 488 of the outer coupler-ring spline portion 460 in the cross-sectional view of FIG. 5 is illustrated in a large scale.

As illustrated in FIG. 5, a height of the outer coupler-ring spline portion 460 on the vehicle-body side is formed to be greater than on the wheel side. Preferably, the height of the outer coupler-ring spline portion 460 may be set to increase toward the vehicle-body-side end F.

The height of the outer coupler-ring spline portion 460 may be set to gradually decrease from the vehicle-body-side end F toward the wheel side. As an example, the outer coupler-ring spline portion 460 is formed such that tooth mountains and tooth valleys are arranged in an alternate manner. The outer peripheral surface forming the tooth mountains may be formed as an inclined surface having a certain inclination angle.

As described above, the coupler ring according to an example embodiment of the present disclosure may be manufactured by cutting out portions corresponding to the tooth-shaped grooves of the inner and outer coupler-ring spline portions in a ring-shaped structure having an outer diameter D1, a first inner diameter D3, and a second inner diameter D4. As described above, in order to form the outer peripheral surface forming the tooth mountains of the outer coupler-ring spline portion as a fine inclined surface, the outer peripheral surface forming the tooth mountains may be preferably subjected to an additional precision cutting process in addition to the cutting process. More preferably, in addition to the tooth mountains, the tooth side surfaces may also be subjected to the additional precision cutting process. In a case in which the tooth valleys are configured so as not to be engaged with the gear ring, the tooth valleys may not be subjected to the additional precision cutting process.

According to an example embodiment of the present disclosure, in a case in which a load in a range of about 6 to 9 tons is applied, considering that the wheel-side end E is raised by 20 μm, as illustrated in FIG. 5, the difference Δh between the height h5 of the outer coupler-ring spline portion 460 at the vehicle-body-side end F and the height h6 of the outer coupler-ring spline portion 460 at the wheel-side end E may be in a range of 10 to 50 μm.

More preferably, according to an example embodiment of the present disclosure, the difference Δh between the height h5 of the outer coupler-ring spline portion 460 at the vehicle-body-side end F and the height h6 of the outer coupler-ring spline portion 460 at the wheel-side end E may be set to be greater than a raise deformation amount ΔS of the outer coupler-ring spline portion 460 at the wheel-side end E. In this case, the raise deformation amount ΔS of the outer coupler-ring spline portion 460 at the wheel-side end E may be determined based on the axial force exerted on the coupler ring during the orbital forming process. The difference Δh between the height h5 of the outer coupler-ring spline portion 460 at the vehicle-body-side end F and the height h6 of the outer coupler-ring spline portion 460 at the wheel-side end E may be determined based on the axial force exerted on the coupler ring during the orbital forming process.

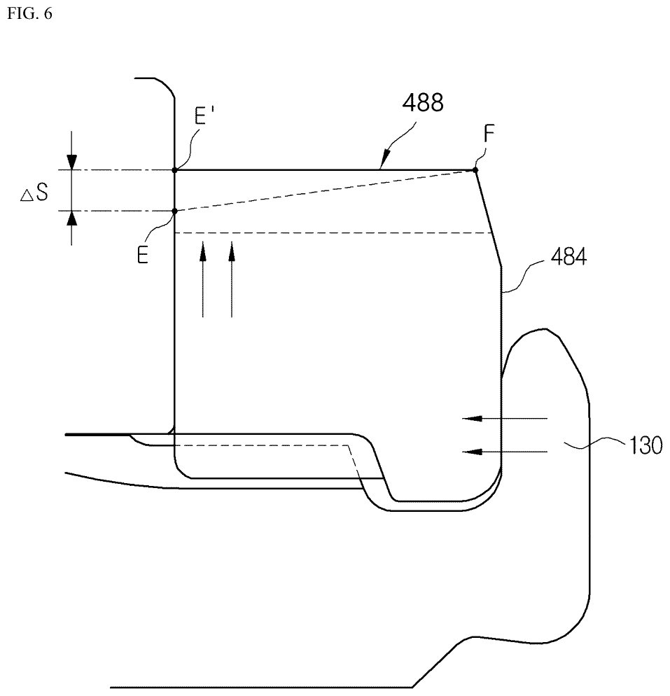

FIG. 6 is a cross-sectional view of the coupler ring deformed by the orbital forming process according to an example embodiment of the present disclosure.

As illustrated in FIG. 6, the wheel-side end E before the orbital forming process is raised and deformed into a wheel-side end E′ due to the axial force (after the orbital forming process), so that the difference Δh between the height h5 of the outer coupler-ring spline portion 460 at the vehicle-body-side F and the height h6 of the outer coupler-ring spline portion 460 at the wheel-side end E is reduced by the raise deformation amount ΔS.

In FIG. 6, for the sake of convenience in description, a phenomenon in which the coupler ring is deformed during the orbital forming process in the structure of the wheel bearing and the coupler ring illustrated in FIG. 4 is illustrated. It should be understood that the phenomenon in which the outer peripheral surface 488 of the coupler ring 400 is unevenly raised and deformed during the orbital forming process generally occurs in a coupler ring in which a relatively large load is applied to the vehicle-body-side side surface during the orbital forming process. Further, it should be understood that a specific structure of the outer peripheral surface of the coupler ring according to the present disclosure is not limited to a structure of a coupler ring having a specific inner peripheral surface structure.

Further, although the phenomenon in which the outer peripheral surface 488 (that is, the tooth mountains) of the coupler ring 400 is unevenly raised and deformed due to the axial force has been mainly described above, tooth side surfaces and the tooth valleys may also be deformed due to the axial force.

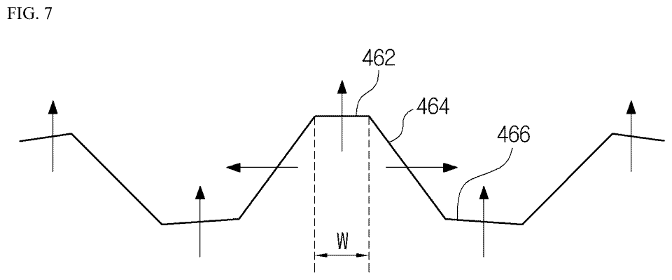

FIG. 7 illustrates a cross-section of the outer coupler-ring spline portion according to an example embodiment of the present disclosure. As illustrated in FIG. 7, the tooth mountains 462 of the outer coupler-ring spline portion 460 may be raised and deformed at the wheel side by the axial force. This has been described in the above. Similarly, as illustrated in FIG. 7, the tooth side surfaces 464 and the tooth valleys 466 of the outer coupler-ring spline portion 460 may also be deformed. The tooth side surfaces 464 may be expanded and deformed in a width direction of the tooth mountains 462 by the axial force. (Similar to the tooth mountains) The tooth valleys 466 may be raised and deformed by the axial force.

According to an example embodiment of the present disclosure, (in addition to setting the height of the tooth mountain as described above) the width W of the tooth mountain 462 and the height of the tooth valley 466 may be set such that the coupler ring and the clutch (more specifically, the gear ring of the clutch) may be more easily coupled to each other.

As an example, the width W of the tooth mountain 462 of the outer coupler-ring spline portion 460 on the vehicle-body side may be formed to be greater than on the wheel side so as to compensate for the tooth side surfaces 464 being expanded and deformed in the width direction of the tooth mountain 462 by the axial force.

Further, the height of the tooth valley 466 of the outer coupler-ring spline portion 460 on the vehicle-body side may be formed to be higher than on the wheel side so as to compensate for the tooth valley 466 being raised and deformed at the wheel side by the axial force.

In the present disclosure, it should be understood that specific configurations described in relation to the tooth mountains may be identically similarly applied with respect to the tooth side surfaces and the tooth valleys.

### 4. Orbital Forming Process

The orbital forming process of the present disclosure may be carried out similarly to a typical orbital forming process. However, as described above, in the present disclosure, the height of the outer coupler-ring spline portion 460 on the vehicle-body side is set to be higher than on the wheel side in consideration of the raise deformation amount ΔS by the axial force generated when applying the preload during the orbital forming process.

Accordingly, one of features of the orbital forming process according to an example embodiment of the present disclosure is to provide an appropriate axial force such that the matter in which the outer peripheral surface of the coupler ring is unevenly raised and deformed during the orbital forming process may be solved by such a height difference.

For example, according to an example embodiment of the present disclosure, the orbital forming process may be preferably performed such that the axial force generated when applying the preload during the orbital forming process is in a range of about 6 to 9 tons.

More preferably, according to an example embodiment of the present disclosure, the load applied to the vehicle-body-side side surface 484 of the coupler ring 400 during the orbital forming process may be set such that the raise deformation amount ΔS of the outer coupler-ring spline portion 460 at the wheel-side end E does not exceed the difference Δh between the height h5 of the outer coupler-ring spline portion 460 at the vehicle-body-side end F and the height h6 of the outer coupler-ring spline portion 460 at the wheel-side end E (before the orbital forming process).

Although the present disclosure has been described with reference to the above example embodiments, it should be noted that various modification, and variations may be devised by those skilled in the art to which the present disclosure pertains without departing from the technical spirit and scope of the present disclosure. Further, the example embodiments described herein are merely examples for explaining the technical sprit of the present disclosure, and the technical sprit of the present disclosure is not limited to the example embodiments. Further, the scope of the present disclosure should be construed within the appended claims, and all technical ideas falling within the equivalent scope thereof should be interpreted as being included in the scope of the disclosure.

EXPLANATION OF REFERENCE NUMERALS

| | |
|---|---|
| 10: Wheel bearing | 100: Wheel hub |
| 120: Small-diameter portion | 130: Bent portion |
| 140: Wheel installation flange | 145: Wheel mounting opening |
| portion | |
| 150: First outer peripheral surface | 152: Outer wheel-hub spline |
| | portion |
| 160: Second outer peripheral surface | 170: Third outer peripheral surface |
| 200: Outer ring | 210: Outer raceway surface |
| 220: Vehicle-body installation flange | 300: Inner ring |
| portion | |
| 310: Inner raceway surface | 400: Coupler ring |
| 420: Inner coupler-ring spline portion | |
| 424: tooth-shaped groove | 440: Inner protrusion portion |
| 442: Inner peripheral surface | 460: Outer coupler-ring spline |
| | portion |
| 462: Tooth mountain | 464: Tooth side surface |
| 466: Tooth valley | 482: Wheel-side side surface |
| 484: Vehicle-body-side side surface | 486: Inner peripheral surface |
| 488: Outer peripheral surface | 500: Rolling body |
| 600: Wheel mounting bolt | A: First interference magnitude |
| B: Second interference magnitude | C: Third interference magnitude |
| D1: Outer diameter | D3: First inner diameter |
| D4: Fourth inner diameter | Tl: Maximum thickness |
| T2: Minimum thickness | E: Wheel-side end |
| E: Raised deformed wheel-side end | F: Vehicle-body-side end |
| W: Width | ΔS: Raise deformation amount |
| Δh: height difference | |

What is claimed is:

1. A coupler ring (400) for a vehicular wheel bearing (10), the coupler ring comprising:
a wheel-side side surface (482);
a vehicle-body-side side surface (484);
an inner peripheral surface (486) connecting the wheel-side side surface (482) and the vehicle-body-side side surface (484); and
an outer peripheral surface (488) connecting the wheel-side side surface (482) and the vehicle-body-side side surface (484),
wherein an inner coupler-ring spline portion (420) is formed on the inner peripheral surface (486),
wherein an outer coupler-ring spline portion (460), which is engaged with a ring gear, is formed on the outer peripheral surface (488), and
wherein a height of the outer coupler-ring spline portion (460) on a vehicle-body side is formed to be greater than that on a wheel side.

2. The coupler ring of claim 1, wherein the height of the outer coupler-ring spline portion (460) is set to increase toward a vehicle-body-side end F.

3. The coupler ring of claim 1, wherein the height of the outer coupler-ring spline portion (460) is set to decrease gradually from a vehicle-body-side end F toward the wheel side.

4. The coupler ring of claim 2, wherein a difference Δh between a height h5 of the outer coupler-ring spline portion (460) at the vehicle-body-side end F and a height h6 of the outer coupler-ring spline portion (460) at a wheel-side end E falls within a range of 10 to 50 μm.

5. The coupler ring of claim 4, wherein a bumper is installed on the outer coupler-ring spline portion (460),
wherein the wheel-side end E of the outer coupler-ring spline portion (460) is brought into contact with a vehicle-body-side side surface of the bumper.

6. The coupler ring of claim 1, wherein the outer coupler-ring spline portion (460) is formed such that tooth mountains and tooth valleys are arranged in an alternate manner, and
wherein an outer peripheral surface of the outer coupler-ring spline portion (460), which forms the tooth mountains, is formed as an inclined surface at a predetermined inclination angle.

7. The coupler ring of claim 6, wherein the predetermined inclination angle of the outer peripheral surface is defined by precision processing of the tooth mountains.

8. The coupler ring of claim 1, wherein a width W of a tooth mountain (462) of the outer coupler-ring spline portion (460) on the vehicle-body side is formed to be greater than on the wheel side.

9. The coupler ring of claim 1, wherein a height of a tooth valley (466) of the outer coupler-ring spline portion (460) on the vehicle-body side is formed to be greater than on the wheel side.

10. A method of manufacturing a vehicular wheel bearing to which the coupler ring of claim 1 is applied, the method comprising:
mounting an inner ring (300) on an outer peripheral surface of a wheel hub (100);
mounting a coupler ring (400) on the outer peripheral surface of the wheel hub (100) to be brought into contact with the inner ring (300); and
bending a vehicle-body-side end portion of the wheel hub (100) to form a bent portion (130) and applying a preload to the coupler ring (400),
wherein, in the applying the preload, an outer coupler-ring spline portion (460) is raised and deformed such that a difference Δh between a height h5 of the outer coupler-ring spline portion (460) at a vehicle-body-side end F and a height h6 of the outer coupler-ring spline portion (460) at a wheel-side end E is decreased.

11. The method of claim 10, wherein, in the applying the preload, the outer coupler ring spline portion (460) is raised by 20 μm or more at the wheel-side end E.

12. The method of claim 10, wherein in the applying the preload, a load in a range of 6 to 9 tons is applied to the vehicle-body-side side surface (484).

13. The method of claim 10, wherein a load applied to the vehicle-body-side side surface (484) in the applying the preload is set such that a raise deformation magnitude ΔS of the outer coupler-ring spline portion (460) at the wheel-side end E does not exceed a difference Δh between the height h5 of the outer coupler-ring spline portion (460) at the vehicle-body-side end F and the height h6 of the outer coupler-ring spline portion (460) at the wheel-side end E.

14. A vehicular wheel bearing to which the coupler ring of claim 1 is finally mounted by an orbital forming process,
wherein, in the coupler ring finally mounted on vehicular wheel bearing, a difference Δh between a height h5 of an outer coupler-ring spline portion (460) at a vehicle-body-side end F and a height h6 of the outer coupler-ring spline portion (460) at a wheel-side end E is decreased.
